(19) United States
(12) Patent Application Publication
(10) Pub. No.: US 2025/0124330 A1
(43) Pub. Date: Apr. 17, 2025

(54) TEAM MEMBER BEHAVIOR IDENTIFICATION IN CUSTOMER COMMUNICATIONS USING COMPUTER-BASED MODELS

(71) Applicant: Wells Fargo Bank, N.A., San Francisco, CA (US)

(72) Inventors: Thomas Mann, Charlotte, NC (US); Ashley Trenholm Kreth, Charlotte, NC (US); Nathan R. Parrish, Chaska, MN (US); Kevin Portis, San Pedro, CA (US); Dane Arnesen, Saint Louis Park, MN (US); Noel P. Volin, Hudson, WI (US); Lihong Han, Cupertino, CA (US); Shailashree Sivaraman, Fremont, CA (US)

(21) Appl. No.: 17/099,666

(22) Filed: Nov. 16, 2020

(51) Int. Cl. G06N 20/00; G06F 40/30; G06N 5/025; G06Q 10/0639; H04L 51/046

(52) U.S. Cl. CPC G06N 20/00; G06F 40/30; G06N 5/025; G06Q 10/06398; H04L 51/046

(57) ABSTRACT

Techniques are described for performing team member behavior identification and classification using a machine learning model and one or more rule-based models for customer communications. A computing system receives a message from a user device. The computing system uses output of a machine learning model to determine whether the message includes an indication of team member behavior including at least one behavior term and at least one team member reference. The computing system also uses output of one or more rule-based models to determine whether the message includes an indication of a type of team member behavior including a type of behavior term and a type of team member reference substantially proximate to each other within the message. Based on the message including the indication of team member behavior, the computing system sends the message to another system corresponding to the type of team member behavior included in the message.

### TECHNICAL FIELD

The disclosure relates to computing systems, and more specifically, computing systems executing models configured to detect patterns.

### BACKGROUND

A customer service contact center is a facility configured to handle incoming messages from customers or potential customers of a business or organization. One function of the contact center is to handle customer service inquiries, such as complaints, focused on one or more services provided by the business. Although many customer service inquiries can be handled through online interactions (e.g., via websites, email, or mobile applications), for some businesses, a contact center may be regarded as necessary. A contact center may include one or more message analysis systems and one or more agent desktop systems used by a number of human agents that are representatives of the organization.

### SUMMARY

In general, this disclosure describes techniques for performing team member behavior identification and classification using a machine learning model and one or more rule-based models for customer communications associated with a business or organization. More specifically, a computing system may receive one or more messages comprising customer service inquiries, such as customer complaints. Some types of customer complaints may comprise team member behavior complaints, e.g., allegations of unethical behavior or descriptions of negative behavior by team members of the organization. Messages that include indications of team member behavior may include at least one behavior term and at least one team member reference.

According to the disclosed techniques, the computing system uses a machine learning model to convert a string of characters included in a message into a sequence of word vectors (e.g., numerical values representing words) and analyze the word vectors to determine a probability that the message includes an indication of team member behavior. The computing system also uses one or more rule-based models to analyze the string of characters included in the message to determine whether the message includes an indication of a specific type of team member behavior. In some examples, the output of the rule-based models may be used to categorize the team member behavior identified as being included in the message based on the output of the machine learning model. In other examples, the output of the rule-based models may override the output of the machine learning model to identify either false negatives or false positives in the output of the machine learning model.

When the computing system determines that the message includes an indication of team member behavior based on the output of the models, the computing system then sends the message to another system corresponding to the type of team member behavior included in the message. For example, when the type of team member behavior included in the message comprises one of a team member allegation or negative team member behavior, the computing system may send the message to another system for escalated handling and resolution. When the type of team member behavior included in the message comprises general behavior, the computing system may log the message as a complaint for standard complaint processing.

In one example, this disclosure is directed to a computing system comprising a memory, and one or more processors in communication with the memory. The one or more processors are configured to: receive a message from a user device, wherein the message comprises a string of characters; determine, based on output of a machine learning model, whether the message includes an indication of team member behavior, wherein the indication of team member behavior includes at least one behavior term and at least one team member reference; determine, based on output of one or more rule-based models, whether the message includes an indication of a type of team member behavior, wherein the indication of the type of team member behavior includes a type of behavior term and a type of team member reference substantially proximate to each other within the message; and based on the message including the indication of team member behavior, send the message to another system corresponding to the type of team member behavior included in the message.

In another example, this disclosure is directed to a method comprising: receiving, by a computing system, a message from a user device, wherein the message comprises a string of characters; determining, by the computing system and based on output of a machine learning model, whether the message includes an indication of team member behavior, wherein the indication of team member behavior includes at least one behavior term and at least one team member reference; determining, by the computing system and based on output of one or more rule-based models, whether the message includes an indication of a type of team member behavior, wherein the indication of the type of team member behavior includes a type of behavior term and a type of team member reference substantially proximate to each other within the message; and based on the message including the indication of team member behavior, sending the message from the computing system to another system corresponding to the type of team member behavior included in the message.

In a further example, this disclosure is directed to a computer-readable medium storing instructions that, when executed by a computing system, cause one or more processors of the computing system to: receive a message from a user device, wherein the message comprises a string of characters; determine, based on output of a machine learning model, whether the message includes an indication of team member behavior, wherein the indication of team member behavior includes at least one behavior term and at least one team member reference; determine, based on output of one or more rule-based models, whether the message includes an indication of a type of team member behavior, wherein the indication of the type of team member behavior includes a type of behavior term and a type of team member reference substantially proximate to each other within the message; and based on the message including the indication of team member behavior, send the message to another system corresponding to the type of team member behavior included in the message.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example contact center within an organization that includes a communication analysis system configured to perform team member behavior identification and classification, in accordance with one or more techniques of this disclosure.

FIG. 2 is a block diagram illustrating an example communication analysis system, in accordance with one or more techniques of this disclosure.

FIG. 3 is a flow diagram illustrating an example operation for performing team member behavior identification and classification, in accordance with one or more techniques of this disclosure.

FIG. 4 is a flow diagram illustrating another example operation for performing team member behavior identification and classification, in accordance with one or more techniques of this disclosure.

### DETAILED DESCRIPTION

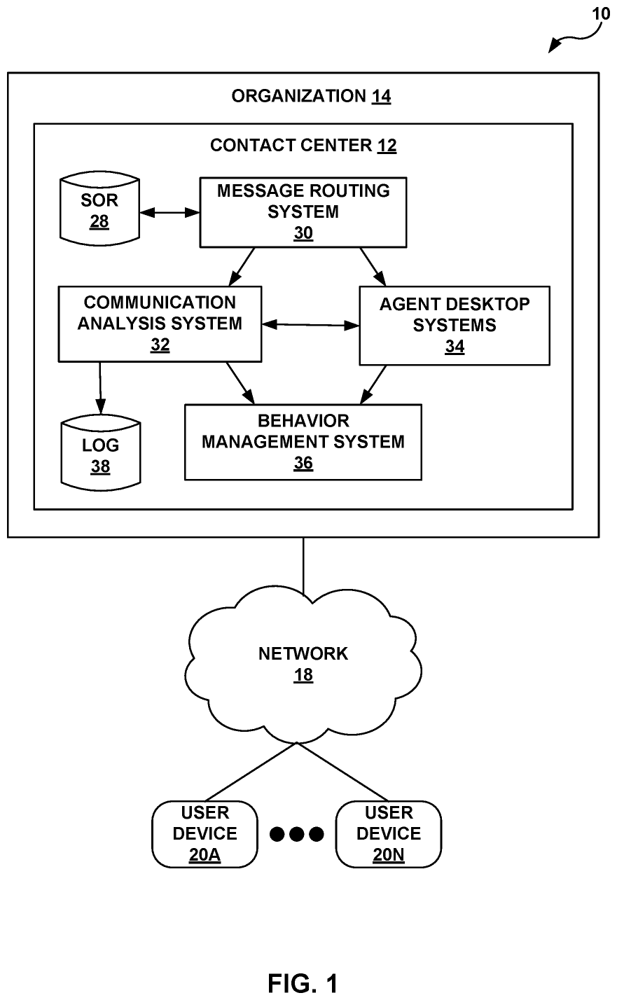

FIG. 1 is a block diagram illustrating computing system 10, including an example contact center 12 within an organization 14 that includes a communication analysis system 32 configured to perform team member behavior identification and classification for incoming messages, in accordance with one or more techniques of this disclosure. As illustrated in FIG. 1, network 10 includes one or more user devices 20A-20N (collectively “user devices 20”) in communication with contact center 12 of organization 14 via a network 18.

User devices 20 may be any suitable communication or computing device, such as a conventional or landline phone, or a mobile, non-mobile, wearable, and/or non-wearable computing device capable of communicating over network 18. For example, each user device 20 may include any one or a combination of a landline phone, a conventional mobile phone, a smart phone, a smart watch, a tablet computer, a personal digital or virtual assistant, a gaming system, a media player, a smart television, an Internet of Things (IoT) device, an automobile or other vehicle, a laptop or notebook computer, a desktop computer, or any other type of wearable, non-wearable, mobile, and non-mobile computing device that may perform operations in accordance with one or more aspects of the present disclosure. One or more of user devices 20 may support communication services over packet-switched networks, e.g., the public Internet, including Voice over Internet Protocol (VOIP). One or more of user devices 20 may also support communication services over circuit-switched networks, e.g., the public switched telephone network (PSTN).

Network 18 may comprise a private network or may comprise a public network, such as the Internet. Although illustrated as a single entity, network 18 may comprise a combination of networks. In some examples, network 18 may comprise one or more of a wide area network (WAN), a local area network (LAN), a virtual private network (VPN), a telephone network (e.g., the PSTN or a wireless network), or another wired or wireless communication network.

Organization 14 may be a financial institution, such as a bank or credit unit, or any other type of institution, company, organization, or the like having a number of team members. Team members may include any entities, employees, contractors, agents, or volunteers of organization 14 that interface with customers, potential customers, vendors, other team members, and/or any other entity on behalf of organization 14. Contact center 12 may comprise a facility configured to process and/or store incoming messages from user devices 20 operated by users that may be customers or potential customers of organization 14. As illustrated, contact center 12 includes several disparate computing systems configured to handle and resolve customer service inquiries with respect to customer accounts with organization 14 or other services provided by organization 14, e.g., servicing existing accounts, opening new accounts, servicing existing loans, opening new loans, and the like.

Contact center 12 may include a centralized or distributed network of the disparate computing systems made up of interconnected desktop computers, laptops, workstations, wireless devices, network-ready appliances, file servers, print servers, or other computing devices. For example, contact center 12 may include one or more data centers including a plurality of servers configured to provide account services interconnected with a plurality of databases and other storage facilities in which customer credentials, customer profiles, and customer accounts are stored. In the illustrated example of FIG. 1, contact center 12 includes a message routing system 30, a communication analysis system 32, agent desktop systems 34, and behavior management system 36. Contact center 12 also includes a system of record (SOR) database 28 configure to store the incoming messages received by contact center 12 from one or more of user devices 20, and a log 38 configured to store one or more of the messages after analysis by communication analysis system 32. The architecture of contact center 12 illustrated in FIG. 1 is shown as one example. In other examples, contact center 12 may include more, fewer, or different computing systems configured to handle and resolve customer complaints included in received messages.

Contact center 12 may support a ticket queue, one or more designated phone lines, and/or one or more designated text-based messaging channels for customers to submit messages regarding customer service inquires including complaints and other comments or concerns. Additionally, contact center 12 may support processes for storing and/or transferring messages received from customers or potential customers. For example, contact center 12 may receive incoming phone calls from user devices 20. Message routing system 30 may route the phone calls to agent desktop systems 34 to enable customers associated with user devices 20 to discuss customer service inquires, including complaints, with human agents using agent desktop systems 34. The live discussions may be recorded by agent desktop systems 34 and converted from audio form to text form (e.g., using a voice-to-text engine) by message routing system 30 for storage in SOR 28. In other examples, message routing system 30 may enable the customers associated with user devices 20 to record voice messages detailing the customer service inquires. Message routing system 30 may then convert the voice messages from audio form to text form for storage in SOR 28. Additionally, or alternatively, contact center 12 may receive incoming messages via data-based communication channels such as email, text messaging, chat messaging, and social media messaging. Message routing system 30 may store the text form messages in SOR 28.

Organization 14 may maintain certain processes and procedures regarding the handling and resolution of customer complaints included in messages received by contact center 12 from customers or potential customers. Some customer complaints may be of a higher priority than other customer complaints. For example, organization 14 may maintain processes and procedures that require escalated handling and resolution of customer complaints that include allegations of unethical behavior or descriptions of negative behavior by team members of organization 14. The types of messages that require escalation under the policies and procedures of organization 14 may be a small portion of a large volume of messages submitted via contact center 12.

Existing manual processes rely on human agents to review each of the incoming messages and identify which of the messages include indications of team member behavior. These manual processes are both subjective and time consuming. In addition, the manual processes alone may result in ineffective evaluation of the messages. For example, human agents evaluate messages subjectively, which may cause discrepancies between evaluations performed by different human agents and potentially permit bias to influence the evaluations. Moreover, the large volume of incoming messages may easily overwhelm a system with only manual processes, causing a delay in evaluation of and response to messages that may include time-sensitive information. In addition, evaluation by human agents may forfeit privacy of messages that include confidential and/or disruptive or offensive material. Furthermore, human agents may not perceive a significance of terms, such as due to subtle rhetoric or extravagant vocabulary in the message, and may fail to classify a message accurately due to misunderstanding. As a result, a system with only manual processes may contribute to an ineffective evaluation of messages to identify and classify team member behavior.

In accordance with the techniques described herein, contact center 12 includes communication analysis system 32 configured to perform team member behavior identification and classification using a machine learning model and one or more rule-based models to analyze customer messages received by contact center 12. Team member behavior comprises any description of behavior by team members (e.g., entities, employees, contractors, agents, or volunteers) acting on behalf of organization 14. Communication analysis system 32 is generally described herein as being configured to identify and classify team member behavior complaints, including allegations of unethical behavior by specifically-referenced team members, descriptions of negative behavior by specifically-referenced team members, or descriptions of negative behavior by generally-referenced team members, for appropriate handing and resolution. In other examples, communication analysis system 32 may be configured to further identify and classify team member behavior compliments including positive team member behavior by specific- or generally-identified team members.

Allegations of unethical behavior may include theft, conflicts of interest, sales practice concerns, bribery or other forms of corruption, bank record falsification or other manipulation, auditing irregularities, deficiencies in accounting controls, harassment, discrimination, insider trading, policy violations related to a code of ethics or the law, retaliation or repetitive rude or unprofessional behavior. Negative behavior may include rudeness, disrespect, or otherwise poor customer service. Specifically-referenced team members may include any entities (e.g., branches, office locations, or business units), employees, contractors, agents, or volunteers of organization 14.

Communication analysis system 32 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, communication analysis system 32 represents cloud computing systems, server farms, and/or server clusters (or portions thereof) that provide services to client devices and other devices or systems. In other examples, communication analysis system 32 may represent or be implemented through one or more virtualized compute instances (e.g., virtual machines, containers) of a data center, cloud computing system, server farm, and/or server cluster. Communication analysis system 32 may communicate with external systems via one or more networks (e.g., contact center 12 and/or network 18). In some examples, communication analysis system 32 may use network interfaces (such as Ethernet interfaces, optical transceivers, radio frequency (RF) transceivers, Wi-Fi or Bluetooth radios, or the like), telephony interfaces, or any other type of interface device that can send and receive information to wirelessly communicate with external systems.

As discussed above, contact center 12 may receive incoming messages from user devices 20, and message routing system 30 may store the received messages in text form in SOR 28. In some examples, message routing system 30 may route received messages to one or both of communication analysis system 32 and agent desktop systems 34 for real-time processing to determine whether the messages include indications of team member behavior. In other examples, message routing system 30 may retrieve one or more messages from SOR 28 and route the retrieved messages to one or both of communication analysis system 32 and agent desktop systems 34 for processing to determine which of the retrieved messages include indications of team member behavior.

In one scenario, communication analysis system 32 may be used to augment existing manual processes in which human agents using agent desktop systems 34 review each of the incoming messages and identify which of the messages include indications of team member behavior. In this scenario, message routing system 30 routes a message to both communication analysis system 32 and agent desktop systems 34 for processing, where communication analysis system 32 is supplemental and attempts to find messages that include indications of team member behavior that were overlooked by the manual processes at agent desktop systems 34 and, thus, not properly escalated for handling and resolution. The combination of the manual processes at agent desktop systems 34 and the computer model-based processes at communication analysis system 32 may provide one or more benefits, including identifying a higher percentage of team member behavior complaints in the large volume of incoming customer messages compared to the manual processes alone without significantly increasing processing time compared to the manual processes alone. In addition, the combination of the manual processes at agent desktop systems 34 and the computer model-based processes at communication analysis system 32 may reduce the occurrences of false negatives in identifying team member behavior included in messages compared to the manual processes alone.

In another scenario, communication analysis system 32 may be used as a stand-alone computer model-based process to analyze each of the incoming messages and determine which of the messages include indications of team member behavior. In this scenario, message routing system 30 routes a message to only communication analysis system 32 for processing. Use of the computer model-based processes at communication analysis system 32 alone may provide one or more benefits, including entirely objective determinations of indications of team member behavior and types of team member behavior included in messages and increased customer privacy compared to the manual processes. In addition, the computer model-based processes at communication analysis system 32 may significantly reduce processing time for the large volume of incoming customer messages by eliminating a need for manual review of the all incoming messages. In either scenario above, manual quality control processes may be used to review at least a sampling of team member behavior determinations made by the computer model-based processes of communication analysis system 32.

Agent desktop systems 34 may include one or more computing devices paired with one or more human agents. Examples of computing devices may include smart speakers, mobile phones (e.g., smartphones), smart watches, personal computers, handheld computers (e.g., tablets), and the like. Upon receipt of a message for processing from message routing system 30, agent desktop systems 34 may present the message for display on a user interface of one of the computing devices for review by a human agent. Agent desktop systems 34 may receive input from the human agent via the user interface on the computing device. The input may indicate whether the human agent identifies team member behavior included in the message. In some examples where the human agent does not identify any team member behavior in the reviewed message, agent desktop systems 34 may send an indication, or in some cases the message itself, to communication analysis system 32 for supplemental, computer model-based processing of the message. In other examples where the human agent identifies team member behavior in the reviewed message, agent desktop systems 34 may send the message directly to behavior management system 36 for escalated handling and resolution.

According to the disclosed techniques, communication analysis system 32 is configured to perform team member behavior identification and classification of customer messages using a machine learning model and one or more rule-based models. As described above, communication analysis system 32 may analyze messages as a supplemental process to the manual processes of agent desktop systems 34 or may analyze messages as a stand-alone process.

Upon receipt of a message for processing from message routing system 30, communication analysis system 32 may perform preprocessing to prepare the message for application to the machine learning model and/or the rule-based models. Communication analysis system 32 determines whether the message includes an indication of team member behavior based on output of the machine learning model, where the indication of team member behavior identified by the machine learning model includes at least one behavior term and at least one team member reference. The behavior term may be any type of behavior term including at least one of an allegation term, a negative behavior term, or, in some cases, a positive behavior term. The team member reference may by any type of team member reference including at least one of a specific team member reference or a general team member reference.

Communication analysis system 32 also determines whether the message includes an indication of a type of team member behavior based on output of the one or more rule-based models. The indication of the type of team member behavior identified by the rule-based models includes a type of behavior term and a type of team member reference that are substantially proximate to each other within the message. The type of behavior term may be one of an allegation term or a negative behavior term. The type of team member reference may be one of a specific team member reference or a general team member reference. The type of team member behavior comprises one of a team member allegation, negative team member behavior, or general behavior. In some examples, communication analysis system 32 may use the output of the rule-based models to categorize the team member behavior identified as being included in the message based on the output of the machine learning model. In other examples, communication analysis system 32 may use the output of the rule-based models to override the output of the machine learning model to identify either false negatives or false positives in the output of the machine learning model.

When communication analysis system 32 determines that a message includes an indication of team member behavior based on the output of the models, communication analysis system 32 sends the message to another system corresponding to the type of team member behavior included in the message. For example, when the type of team member behavior included in the message comprises one of a team member allegation or negative team member behavior, communication analysis system 32 may send the message to behavior management system 36 for escalated handling and resolution. When the type of team member behavior included in the message comprises general behavior, communication analysis system 32 may enter the message in log 38 as a complaint for standard complaint processing. In cases where the message does not include any indication of team member behavior, communication analysis system 32 may store the message either in log 38 as not team member behavior or in SOR 28 without further documenting the analysis of the message with respect to team member behavior. In some examples, for at least a sampling of the messages, communication analysis system 32 may send indications, or in some cases the messages themselves, to agent desktop systems 34 for supplemental manual processing of the message (e.g., for quality control purposes).

Behavior management system 36 may receive messages determined by communication analysis system 32 and/or agent desktop systems 34 to include team member allegations or negative team member behavior. Behavior management system 36 may manage the escalated handling and resolution of the messages. Escalating a message to behavior management system 36 may include flagging the message and alerting one or more teams within behavior management system 36 responsible for resolution of the type of team member behavior. Flagging of the message and alerting the responsible teams within behavior management system 36 may enable prioritization of the message to ensure that the team member behavior complaint included in the message is investigated and resolved in a timely manner.

In some cases, communication analysis system 32 may function in conjunction with other systems of contact center 12 (e.g., message routing system 30, agent desktop systems 34, and/or behavior management system 36). In other cases, communication analysis system 32 may function independently. In such cases, message routing system 30, agent desktop systems 34, and behavior management system 36 may not be necessary to perform the techniques described in this disclosure.

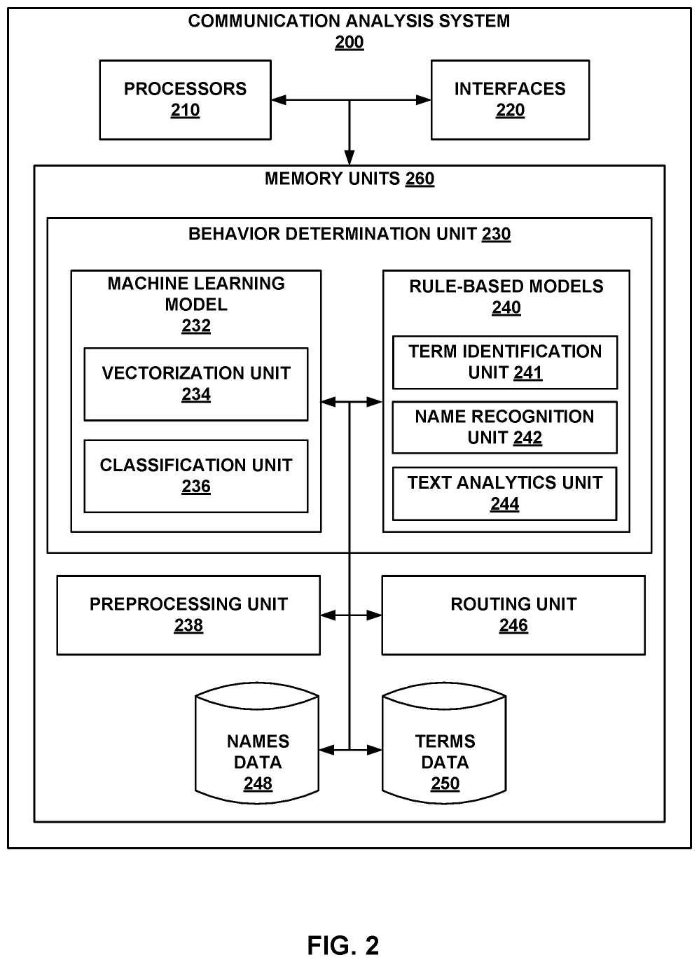

FIG. 2 is a block diagram illustrating an example communication analysis system 200, in accordance with one or more techniques of this disclosure. Communication analysis system 200 may operate substantially similar to communication analysis system 32 contact center 12 of FIG. 1. One or more aspects of communication analysis system 200 of FIG. 2 may be described within the context of contact center 12 of FIG. 1. The architecture of communication analysis system 200 illustrated in FIG. 2 is shown for exemplary purposes only. Communication analysis system 200 should not be limited to the illustrated example architecture. In other examples, communication analysis system 200 may be configured in a variety of ways.

Communication analysis system 200 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, communication analysis system 200 represents a cloud computing system, server farm, and/or server cluster (or portion thereof) that provides services to client devices and other devices or systems. In other examples, communication analysis system 200 may represent or be implemented through one or more virtualized compute instances (e.g., virtual machines, containers) of a data center, cloud computing system, server farm, and/or server cluster.

As shown in the example of FIG. 2, communication analysis system 200 includes one or more processors 210, one or more interfaces 220, and memory units 260. Communication analysis system 200 also includes behavior determination unit 230 with machine learning model 232 and rule-based models 240, preprocessing unit 238, routing unit 246, names data 248, and terms data 250, which may be implemented as program instructions and/or data stored in memory units 230 and executable by processors 210. Memory units 260 of communication analysis system 200 may also store an operating system (not shown) executable by processors 210 to control the operation of components of communication analysis system 200. As illustrated, the components, units, or modules of communication analysis system 200 are coupled (physically, communicatively, and/or operatively) using communication channels for inter-component communications. In some examples, the communication channels may include a system bus, a network connection, an inter-process communication data structure, or any other method for communicating data.

Processors 210, in one example, may comprise one or more processors that are configured to implement functionality and/or process instructions for execution within communication analysis system 200. For example, processors 210 may be capable of processing instructions stored by memory units 260. Processors 210 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Communication analysis system 200 may utilize interfaces 220 to communicate with external systems via one or more networks, e.g., contact center 12 and/or network 18 of FIG. 1. Interfaces 220 may be network interfaces (such as Ethernet interfaces, optical transceivers, radio frequency (RF) transceivers, Wi-Fi or Bluetooth radios, or the like), telephony interfaces, or any other type of devices that can send and receive information. In some examples, communication analysis system 200 utilizes interfaces 220 to wirelessly communicate with external systems (e.g., message routing system 30, agent desktop systems 34, and behavior management system 36 of contact center 12 from FIG. 1).

Memory units 260 may be configured to store information within communication analysis system 200 during operation. Memory units 260 may include a computer-readable storage medium or computer-readable storage device. In some examples, memory units 260 may include one or more of a short-term memory or a long-term memory. Memory units 260 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory units 260 are used to store program instructions for execution by processors 210. Memory units 260 may be used by software or applications running on communication analysis system 200 to temporarily store information during program execution.

In the illustrated example of FIG. 2, communication analysis system 200 includes behavior determination unit 230, preprocessing unit 238, routing unit 246, names data 248, and terms data 250. Behavior determination unit 230 includes machine learning model 232 and one or more rule-based models 240. Machine learning model 232 includes vectorization unit 234 and classification unit 236. Rule-based models 240 include term identification unit 241, name recognition unit 242, and text analytics unit 244.

Communication analysis system 200 receives a message from a user device for team member behavior identification and classification by behavior determination unit 230. For example, interfaces 220 of communication analysis system 200 may receive the message from message routing system 30 within contact center 12 of FIG. 1. Message routing system 30 may receive the message from the one of user device 20 in text form and send the text form message comprising a string of characters to communication analysis system 200. In other cases, message routing system 20 may receive the message from the one of user device 20 in audio form, convert the audio form to text form using a voice-to-text engine, and send the text form message comprising a string of characters to communication analysis system 200. In other examples, communication analysis system 200 may receive the message from SOR 28 in text form and send the text form message comprising a string of characters to communication analysis system 200.

Upon receipt of the message comprising a string of characters (e.g., words, numbers, special characters, etc.), communication analysis system 200 may apply the message to preprocessing unit 238 configured to prepare the message for application to machine learning model 232 and/or rule-based models 240. For example, preprocessing unit 238 may remove one or more special characters, remove one or more neutral words such as articles or prepositions, correct spelling of one or more words, grouping together inflected forms of a word (i.e., lemmatization), and/or convert one or more numerical symbols to words. Preprocessing unit 238 may prepare the message such that machine learning model 232 and/or rule-based models 240 of behavior determination unit 230 may efficiently and accurately process the string of characters included in the message.

According to the techniques described in this disclosure, behavior determination unit 230 performs team member behavior identification and classification for the message using machine learning model 232 and one or more rule-based models 240. Behavior determination unit 230 determines whether the message includes an indication of team member behavior based on output of machine learning model 232. Behavior determination unit 230 also determines whether the message includes an indication of a type of team member behavior based on output of rule-based models 240.

Behavior determination unit 230 applies the message to machine learning model 232. An indication of team member behavior identified by machine learning model 232 includes at least one behavior term and at least one team member reference. The behavior term may be any type of behavior term including at least one of an allegation term, a negative behavior term, or, in some cases, a positive behavior term. The team member reference may by any type of team member reference including at least one of a specific team member reference or a general team member reference. As described herein, team member behavior complaints fall into three types or categories: team member allegation, negative team member behavior, or general behavior. Machine learning model 232, however, is configured to identify any instance where a message includes an indication of team member behavior and does not segment the identified team member behavior into the defined types or categories.

Machine learning model 232 may comprise a function configured to be executed by processors 210. The function may include nodes, layers, and connections, and the function may be represented by equations having a plurality of variables and a plurality of known coefficients. In some examples, machine learning model 232 may implement supervised learning (e.g., may classify sets of data into groups). For example, a set of data, such as data indicative of a message received by communication analysis system 200, may be classified as including or not including an indication of team member behavior.

Machine learning algorithms, such as the function of machine learning model 232, may be trained using a training process to create data-specific models, such as machine learning model 232. After the training process, the created model may be capable of determining an output data set based on an input data set (e.g., match a set of word vectors representing a string of characters included in a message to one or more known characteristics associated with indications of team member behavior). In some examples, communication analysis system 200 may train machine learning model 232 based on a collection of messages. The collection of messages may have a known association or a known lack of association with team member behavior. Based on the training with the collection of messages, machine learning model 232 may learn to convert a string of characters included in a message to word vectors and, based on the word vectors, classify the message as including an indication of team member behavior or as not including an indication of team member behavior. In some cases, machine learning model 232 may function substantially similar another example machine learning model trained to perform complaint identification and classification, described in more detail in U.S. patent application Ser. No. 16/781,620, filed Feb. 4, 2020, the entire contents of which are incorporated herein by their reference.

Vectorization unit 234 of machine learning model 232 may be trained to develop a token dictionary and a word vector database based on a set of training data including words previously found in parsed and evaluated messages. The token dictionary and the word vector database may contain relative meanings of words and may further express the relativity of the words numerically and multidimensionally. For example, two similar word vectors may correspond to words with similar semantic meanings, and two dissimilar word vectors may correspond to words with dissimilar semantic meanings. Behavior determination unit 230 may retrain vectorization unit 234 periodically, such as monthly, bimonthly, or annually.

Upon receipt of a message for analysis, vectorization unit 234 of machine learning model 232 generates one or more word vectors (i.e., numerical values) representative of the string of characters included in the message, such as by performing word embedding. Each word vector may be generated in a multidimensional space such that a magnitude and a direction of the word vector signify a semantic meaning of the word. More specifically, vectorization unit 234 may parse the string of characters included in the message into a set of terms including words or phrases. Vectorization unit 234 may convert each term into a token by mapping each term to a corresponding token in the token dictionary, thus producing a set of tokens corresponding to the set of terms included in the message. Each token may be a numerical value, such as a binary value. Vectorization unit 232 then translates the set of tokens into a set of word vectors, where each word vector is a multidimensional representation of a corresponding unidimensional token. Each word vector may include information indicative of the magnitude and direction of the word vector within a multidimensional space, where the information indicative of the magnitude and the direction represents information associated with one or more characteristics of the set of terms included in the message. For example, the characteristics may correspond to one or more behavior terms and one or more team member references that are predictive of an indication of team member behavior included in the message.

Using the multidimensional word vectors representative of the string of characters included in the message, classification unit 236 of machine learning model 232 analyzes an aggregate (e.g., average) word vector value for the message to predict whether the message includes an indication of team member behavior. For example, the aggregate word vector value may be representative of a quantity of terms included in the message that comprise team member behavior terms and/or team member references, or the aggregate word vector value may be representative of a magnitude of a negative meaning of the team member behavior terms and/or a level of specificity of the team member references. As such, classification unit 236 may classify a message as including an indication of team member behavior if the set of word vectors for the message based on the aggregate word vector value for the message. More specifically, classification unit 236 may determine a propensity score for the message that comprises a probability that the message includes an indication of team member behavior based on the aggregate word vector value for the message. For example, the propensity score may be between 0 and 1, with 0 indicating that the message does not include an indication of team member behavior and 1 indicating that the message does include an indication of team member behavior.

Behavior determination unit 230 compares the propensity score for the message output from machine learning model 232 to a score threshold to determine whether the message includes an indication of team member behavior. In the above example where the propensity score is between 0 and 1, the score threshold may be equal to 0.5 such that for a message having a propensity score greater than 0.5 (i.e., more probable than not that the message includes an indication of team member behavior), behavior determination unit 230 may determine that the message includes an indication of team member behavior. In other examples, the score threshold may be smaller, e.g., approximately equal to 0.3 or 0.4, may be larger, e.g., approximately equal to 0.6 or 0.7.

In addition to applying the message to machine learning model 232, behavior determination unit 230 applies the message to rule-based models 240. An indication of the type of team member behavior identified by rule-based models 240 includes a type of behavior term and a type of team member reference that are substantially proximate to each other within the message. The type of behavior term may be one of an allegation term or a negative behavior term. The type of team member reference may be one of a specific team member reference or a general team member reference. The type of team member behavior comprises one of team member allegation, negative team member behavior, or general behavior. In some examples, rule-based models 240 may include multiple different models where each model is configured to identify a different type of team member behavior, e.g., team member allegation, negative team member behavior, or general behavior.

Term identification unit 241 of rule-based models 240 analyzes the string of characters included in the message to determine whether the string of characters comprises one of a negative behavior term included in a list of negative behavior terms or an allegation term from a list of allegation terms. Communication analysis system 200 may store the list of negative behavior terms and the list of allegation terms as terms data 250. The allegation terms in terms data 250 may include, for example, “abuse,” “cheat,” “corruption,” “misconduct,” or “unethical.” The negative behavior words in terms data 250 may include, for example, “angry,” “complain,” “disrespectful,” or “offended.” Term identification unit 241 may compare each term included in the message against the lists of terms within terms data 250. Term identification unit 241 may store any identified allegation term or negative behavior term from the message that matches a term in terms data 250 as well as the location of the term within the message (e.g., fifth word, fifteenth word, or fiftieth word of the message).

Name recognition unit 242 of rule-based models 240 also analyze the string of characters included in the message to determine whether the string of characters comprises one of a specific team member reference or a general team member reference. Communication analysis system 200 may store a list of general team member references, e.g., “branch,” “office,” “teller,” “representative,” or “manager,” in names data 248. In some scenarios, communication analysis system 200 may further store a list of specific team member references (e.g., specific entity names, employee names, contractor names, agent names, or volunteer names) in names data 248. In other scenarios, names data 248 may comprise a database maintained by human resources for organization 14 such that name recognition unit 242 may perform a lookup in names data 248 to determine whether a specific name reference included in the message matches with an entity, employee, contractor, agent, or volunteer of organization 14 such that the specific name reference comprises a specific team member reference and not a third-party reference. Name recognition unit 242 may compare each term included in the message against the information stored in names data 248. Name recognition unit 242 may store any identified specific team member reference or general team member reference from the message that matches a reference in names data 248 as well as the location of the reference in the message (e.g., third word, fifth word, or tenth word of the message).

Text analytics unit 244 of rule-based models 240 may further analyze the string of characters included in the message based on a term window (e.g., an 8-term or 10-term window) to determine whether the one of the negative behavior term or the allegation term is substantially proximate to the one of the specific team member reference or the general team member reference within the message. More specifically, text analytics unit 244 may compare a location within the message of an identified negative behavior term or allegation term to a location within the message of an identified specific team member reference or general team member reference. For example, if the message includes a specific name reference “Leroy” that matches a specific team member reference from names data 248 and also includes a behavior term “cheat” that matches an allegation term from terms data 250, then text analytics unit 244 may compare the location of the reference “Leroy” within the message to the location of the term “cheat” within the message. If the identified terms satisfy a proximity threshold (e.g., are within the predetermined term window), then text analytics unit 244 may output an indication that the message includes a certain type of team member behavior.

As discussed above, rule-based models 240 may include multiple different models where each model is configured to identify a different type of team member behavior. In accordance with the disclosed techniques, rule-based models 240 may include a team member allegation rule-based model, a negative team member behavior rule-based model, or a general behavior rule-based model. Communication analysis system 200 may apply the message to each of the rule-based models 240 and, based on the analysis, each of the rule-based models 240 outputs a flag for the message that indicates whether the message includes an indication of the respective type of team member behavior.

As one example, the team member allegation rule-based model may determine whether the string of characters included in the message comprises an allegation term and a specific team member reference substantially proximate to each other within the message, and output a binary flag that indicates whether or not the message includes an indication of team member allegation. As another example, the negative team member behavior rule-based model may determine whether the string of characters included in the message comprises a negative behavior term and a specific team member reference substantially proximate to each other within the message, and output a binary flag that indicates whether or not the message includes an indication of negative team member behavior. As a further example, the general behavior rule-based model may determine whether the string of characters included in the message comprises one of a negative behavior term or an allegation term and a general team member reference substantially proximate to the one of the negative behavior term or the allegation term within the message, and output a binary flag that indicates whether or not the message includes an indication of general behavior.

Based on the output of machine-learning model 232 and rule-based models 240, behavior determination unit 230 determines whether the message includes an indication of team member behavior. In cases where the message includes the indication of team member behavior, routing unit 246 of communication analysis system 200 sends the message to another system corresponding to the type of team member behavior included in the message. In some examples, behavior determination unit 230 may use the output of the rule-based models 240 to categorize the team member behavior identified as being included in the message based on the output of machine learning model 232. In other examples, behavior determination unit 230 may use the output of the rule-based models 240 to override the output of machine learning model 232 and identify either false negatives or false positives in the output of machine learning model 232.

When the one or more flags output from rule-based models 240 indicates that the type of team member behavior included in the message comprises one of team member allegation or negative team member behavior, routing unit 246 may send the message to another system for escalated handling and resolution, e.g., behavior management system 36 from FIG. 1. To escalate the message to behavior management system 36, behavior determination unit 230 and/or routing unit 246 may flag the message in order to alert one or more teams within behavior management system 36 responsible for resolution of the type of team member behavior. When the one or more flags output from rule-based models 240 indicates that the type of team member behavior included in the message comprises general behavior, routing unite 246 may log the message, e.g., in log 38 from FIG. 1, as a complaint.

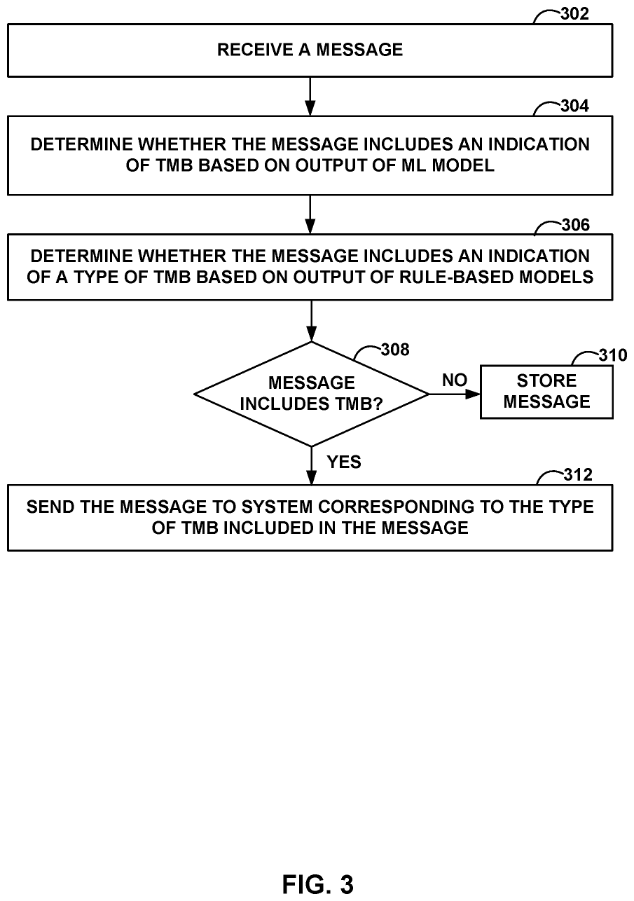

FIG. 3 is a flow diagram illustrating an example operation for performing team member behavior identification and classification, in accordance with one or more techniques of this disclosure. The example operation of FIG. 3 is described with respect to communication analysis system 200 of FIG. 2.

Communication analysis system 200 receives a message from a user device (302). With respect to the example system 10 illustrated in FIG. 1, communication analysis system 200 may receive the message via message routing system 30 within contact center 12 of organization network 14. Message routing system 30 may receive the message from the one of user device 20 in text form (e.g., an email, a text message, a chat message, etc.) and send the text form message comprising a string of characters to communication analysis system 200. In other cases, message routing system 20 may receive the message from the one of user device 20 in audio form (e.g., a voice message) and convert the audio form to text form using a voice-to-text engine. Message routing system 20 may then send the text form message comprising a string of characters to communication analysis system 200. In other examples, communication analysis system 200 may receive the message from a system of record (SOR) database, e.g., SOR 28 from FIG. 1. In any of the above examples, communication analysis system 32 may perform preprocessing to prepare the message for application to machine learning model 232 and/or rule-based models 240.

Behavior determination unit 230 of communication analysis system 200 determines whether the message includes an indication of team member behavior based on output of machine learning model 232 (304). An indication of team member behavior identified by machine learning model 232 includes at least one behavior term and at least one team member reference. The behavior term may be any type of behavior term including at least one of an allegation term, a negative behavior term, or, in some cases, a positive behavior term. The team member reference may by any type of team member reference including at least one of a specific team member reference or a general team member reference. Machine learning model 232 may perform word embedding to generate one or more word vectors representative of the string of characters included in the message. Each word vector may be generated in a multidimensional space such that the magnitude and direction of the word vector signify a semantic meaning of the word. Machine learning model 232 may determine whether the aggregate meaning encoded by a set of word vectors represents the indication of team member behavior.

Behavior determination unit 230 of communication analysis system 200 also determines whether the message includes an indication of a type of team member behavior based on output of one or more rule-based models 240 (306). An indication of the type of team member behavior identified by rule-based models 240 includes a type of behavior term and a type of team member reference that are substantially proximate to each other within the message. The type of behavior term may be one of an allegation term or a negative behavior term. The type of team member reference may be one of a specific team member reference or a general team member reference. The type of team member behavior comprises one of team member allegation, negative team member behavior, or general behavior.

Rule-based models 240 analyze the string of characters included in the message to determine whether the string of characters comprises one of a negative behavior term included in a list of negative behavior terms or an allegation term from a list of allegation terms. Rule-based models 240 also analyze the string of characters included in the message to determine whether the string of characters comprises one of a specific team member reference or a general team member reference. Rule-based models 240 may analyze the string of characters based on a term window (e.g., an 8-term or 10-term window) to determine whether the one of the negative behavior term or the allegation term is substantially proximate to the one of the specific team member reference or the general team member reference within the message. In some examples, rule-based models 240 may include multiple different models where each model is configured to identify a different type of team member behavior, e.g., team member allegation, negative team member behavior, or general behavior.

In the case where the message includes the indication of team member behavior (YES branch of 308), routing unit 246 of communication analysis system 200 sends the message to another system corresponding to the type of team member behavior included in the message (312). For example, routing unit 246 may send the message to another system for escalated handling and resolution, e.g., behavior management system 36 from FIG. 1, when the type of team member behavior comprises one of team member allegation or negative team member behavior. Escalating the message to behavior management system 36 may include flagging the message and alerting one or more teams within behavior management system 36 responsible for resolution of the type of team member behavior. As another example, routing unit 246 may log the message, e.g., in log 38 from FIG. 1, as a complaint when the type of team member behavior comprises general behavior.

In the case where the message does not include any indication of team member behavior (NO branch of 308), routing unit 246 of communication analysis system 200 may store the message (310). For example, routing unit 246 may log the message, e.g., in log 38 from FIG. 1, as not team member behavior or may simply store or maintain the message in the SOR database, e.g., SOR 28 from FIG. 1, without further documenting the analysis of the message with respect to team member behavior.

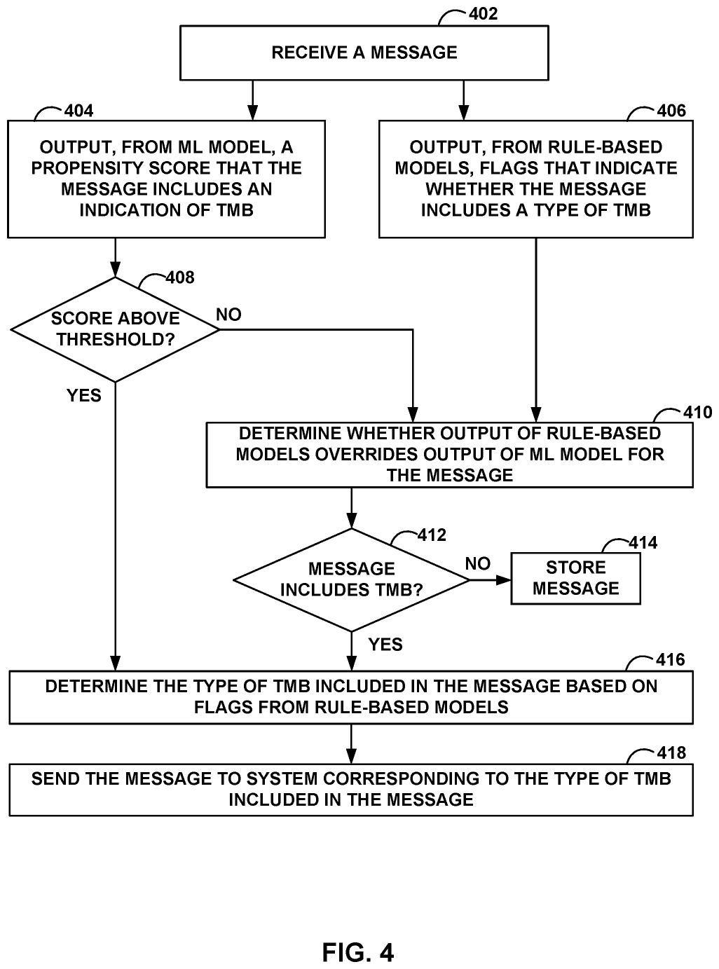

FIG. 4 is a flow diagram illustrating another example operation for performing team member behavior identification and classification, in accordance with one or more techniques of this disclosure. The example operation of FIG. 4 is described with respect to communication analysis system 200 of FIG. 2.

Communication analysis system 200 receives a message from a user device (302). As discussed above, with respect to the example system 10 illustrated in FIG. 1, communication analysis system 200 may receive the message via message routing system 30 within contact center 12 of organization network 14. In other examples, communication analysis system 200 may receive the message from a SOR database, e.g., SOR 28 from FIG. 1. In any of the above examples, communication analysis system 200 receives the message in text form comprising a string of characters and may perform preprocessing to prepare the message for application to machine learning model 232 and/or rule-based models 240.

Behavior determination unit 230 applies the message to machine learning model 232. Machine learning model 232 generates one or more word vectors representative of the string of characters included in the message, and analyzes the word vectors to determine whether the message includes an indication of team member behavior. Based on the analysis, machine learning model 232 outputs a propensity score for the message that comprises a probability that the message includes an indication of team member behavior (404). For example, the propensity score may be between 0 and 1, with 0 indicating that the message does not include an indication of team member behavior and 1 indicating that the message does include an indication of team member behavior.

Behavior determination unit 230 also applies the message to one or more rule-based models 240. Each of the rule-based models 240 analyzes the string of characters included in the message to determine whether the message includes an indication of a respective type of team member behavior, e.g., team member allegation, negative team member behavior, or general behavior. Based on the analysis, each of the rule-based models 240 outputs a flag for the message that indicates whether the message includes an indication of the respective type of team member behavior (406).

Behavior determination unit 230 compares the propensity score for the message output from machine learning model 232 to a score threshold to determine whether the message includes an indication of team member behavior. In the above example where the propensity score is between 0 and 1, the score threshold may be equal to 0.5 such that for a message having a propensity score greater than 0.5 (i.e., more probable than not that the message includes an indication of team member behavior), behavior determination unit 230 may determine that the message includes an indication of team member behavior.

Based on the propensity score for the message output from machine learning model 232 being less than or equal to a score threshold (NO branch of 408), behavior determination unit 230 determines whether the output of rule-based models 240 overrides the output of machine learning model 232 for the message to identify a false negative in the output of machine learning model 232 (410). In cases where the output of rule-based models 240 overrides the output of ML model 232 and where the output of rule-based models 240 indicates that the message includes a type of team member behavior, behavior determination unit 230 determines that the message includes the indication of team member behavior (YES branch of 412). Behavior determination unit 230 then determines the type of team member behavior included in the message based on the flags output from rule-based models 240 (416).

Routing unit 246 of communication analysis system 200 then sends the message to another system corresponding to the type of team member behavior included in the message (418). For example, routing unit 246 may send the message to another system for escalated handling and resolution, e.g., behavior management system 36 from FIG. 1, when the type of team member behavior comprises one of team member allegation or negative team member behavior. Escalating the message to behavior management system 36 may include flagging the message and alerting one or more teams within behavior management system 36 responsible for resolution of the type of team member behavior. As another example, routing unit 246 may log the message, e.g., in log 38 from FIG. 1, as a complaint when the type of team member behavior comprises general behavior.

Conversely, in cases where the output of rule-based models 240 does not override the output of machine learning model 232 and/or where the output of rule-based models 240 indicates that the message does not include any type of team member behavior, behavior determination unit 230 determines that the message does not include any indication of team member behavior (NO branch of 412) and routing unit 246 of communication analysis system 200 may store the message (414). For example, routing unit 246 may log the message, e.g., in log 38 from FIG. 1, as not team member behavior or may simply store or maintain the message in the SOR database, e.g., SOR 28 from FIG. 1, without further documenting the analysis of the message with respect to team member behavior.

Based on the propensity score for the message output from machine learning model 232 being greater than a score threshold (YES branch of 408), behavior determination unit 230 determines that the message includes an indication of team member behavior. Behavior determination unit 230 then determines the type of team member behavior included in the message based on the flags output from rule-based models 240 (416). Routing unit 246 of communication analysis system 200 then sends the message to another system corresponding to the type of team member behavior included in the message (418).

In some cases where the output of machine learning model 232 indicates that the message includes team member behavior, the output of rule-based models 240 may indicate that the message does not include any type of team member behavior. In such cases, the output of rule-based models 240 may override the output of machine learning model 232 for the message to identify a false positive in the output of machine learning model 232, and routing unit 246 of communication analysis system 200 may store the message as not team member behavior (414). A false positive in the output of machine learning model 232 may occur in cases where the message includes an indication of positive team member behavior that is identified as team member behavior by machine learning model 232 but is not identified as one of the defined types of team member behavior by rule-based models 240.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A computing system comprising:
a memory; and
one or more processors in communication with the memory and configured to:
receive a message from a user device, wherein the message comprises a string of characters;
determine, based on output of a machine learning model, whether the message includes an indication of team member behavior, wherein the indication of team member behavior includes at least one behavior term and at least one team member reference;
determine, based on output of one or more rule-based models, whether the message includes an indication of a type of team member behavior, wherein the indication of the type of team member behavior includes:
a type of behavior term at a first location within the message, wherein the type of behavior term comprises one of an allegation term or a negative behavior term, and
a type of team member reference at a second location within the message that is proximate to the first location within the message, wherein the type of team member reference comprises one of a specific team member reference or a general team member reference; and
based on the message including the indication of team member behavior, send the message to another system corresponding to the type of team member behavior included in the message.

2. The computing system of claim 1, wherein the one or more processors are configured to determine whether the output of the rule-based models overrides the output of the machine learning model to identify one of false negatives or false positives in the output of the machine learning model.

3. The computing system of claim 1, wherein the at least one behavior term comprises any type of behavior term including at least one of the allegation term, the negative behavior term, or a positive behavior term, and wherein the at least one team member reference comprises any type of team member reference including at least one of the specific team member reference or the general team member reference.

4. The computing system of claim 1, wherein the type of team member behavior comprises one of team member allegation, negative team member behavior, or general behavior.

5. The computing system of claim 1, wherein the one or more processors are further configured to execute the machine learning model, wherein the machine learning model includes instructions that cause the one or more processors to:
analyze one or more word vectors representative of the string of characters included in the message for the indication of team member behavior; and
output a propensity score for the message that comprises a probability that the message includes the indication of team member behavior.

6. The computing system of claim 5, wherein, to determine whether the message includes the indication of team member behavior, the one or more processors are configured to:
compare the propensity score for the message to a score threshold; and
based on the propensity score for the message being greater than the score threshold, determine that the message includes the indication of team member behavior.

7. The computing system of claim 1, wherein the one or more processors are further configured to execute the one or more rule-based models, and wherein to determine whether the message includes the indication of the type of team member behavior, the one or more rule-based models include instructions that cause the one or more processors to:
analyze the string of characters included in the message for the indication of the type of team member behavior; and
output a flag for the message that indicates whether the message includes the indication of the type of team member behavior.

8. The computing system of claim 7, wherein each of the one or more rule-based models is configured to identify a different type of team member behavior.

9. The computing system of claim 7, wherein, to analyze the string of characters included in the message for the indication of the type of team member behavior, the one or more processors are configured to:
determine whether the string of characters comprises one of the negative behavior term included in a list of negative behavior terms or the allegation term from a list of allegation terms;
determine whether the string of characters comprises one of the specific team member reference or the general team member reference; and
determine whether the one of the negative behavior term or the allegation term at the first location within the message is proximate to the one of the specific team member reference or the general team member reference at the second location within the message.

10. The computing system of claim 9, wherein the type of team member behavior comprises negative team member behavior, and wherein the one or more processors are configured to, based on a determination that the string of characters comprises the negative behavior term at the first location within the message and the specific team member reference at the second location within the message proximate to the first location within the message, output the flag for the message that indicates that the message includes the indication of negative team member behavior.

11. The computing system of claim 9, wherein the type of team member behavior comprises team member allegation, and wherein the one or more processors are configured to, based on a determination that the string of characters comprises the allegation term at the first location within the message and the specific team member reference at the second location within the message proximate to first location within the message, output a flag for the message that indicates that the message includes an indication of team member allegation.

12. The computing system of claim 9, wherein the type of team member behavior comprises general behavior, and wherein the one or more processors are configured to, based on a determination that the string of characters comprises the one of the negative behavior term or the allegation term at the first location within the message and the general team member reference at the second location within the message proximate to the one of the negative behavior term or the allegation term at the first location within the message, output a flag for the message that indicates that the message includes an indication of general behavior.

13. The computing system of claim 1, wherein to send the message to another system corresponding to the type of team member behavior included in the message, the one or more processors are configured to log the message as a complaint when the type of team member behavior comprises general behavior.

14. The computing system of claim 1, wherein to send the message to another system corresponding to the type of team member behavior included in the message, the one or more processors are configured to send the message to a behavior management system when the type of team member behavior comprises one of team member allegation or negative team member behavior.

15. A method comprising:
receiving, by a computing system, a message from a user device, wherein the message comprises a string of characters;
determining, by the computing system and based on output of a machine learning model, whether the message includes an indication of team member behavior, wherein the indication of team member behavior includes at least one behavior term and at least one team member reference;
determining, by the computing system and based on output of one or more rule-based models, whether the message includes an indication of a type of team member behavior, wherein the indication of the type of team member behavior includes:
a type of behavior term at a first location within the message, wherein the type of behavior term comprises one of an allegation term or a negative behavior term, and
a type of team member reference at a second location within the message that is proximate to the first location within the message, wherein the type of team member reference comprises one of a specific team member reference or a general team member reference; and
based on the message including the indication of team member behavior, sending the message from the computing system to another system corresponding to the type of team member behavior included in the message.

16. The method of claim 15, further comprising determining whether the output of the rule-based models overrides the output of the machine learning model to identify one of false negatives or false positives in the output of the machine learning model.

17. The method of claim 15, further comprising executing the machine learning model on one or more processors of the computing system, wherein executing the machine learning model comprises:
analyzing one or more word vectors representative of the string of characters included in the message for the indication of team member behavior; and
outputting a propensity score for the message that comprises a probability that the message includes the indication of team member behavior.

18. The method of claim 17, wherein determining whether the message includes the indication of team member behavior comprises:
comparing the propensity score for the message to a score threshold; and
based on the propensity score for the message being greater than the score threshold, determining that the message includes the indication of team member behavior.

19. The method of claim 15, wherein determining whether the message includes the indication of the type of team member behavior comprises executing the one or more rule-based models on one or more processors of the computing system, wherein executing the one or more rule-based models comprises:
analyzing the string of characters included in the message for the indication of the type of team member behavior; and
outputting a flag for the message that indicates whether the message includes the indication of the type of team member behavior.

20. Non-transitory computer-readable media storing instructions that, when executed by a computing system, cause one or more processors of the computing system to:
receive a message from a user device, wherein the message comprises a string of characters;
determine, based on output of a machine learning model, whether the message includes an indication of team member behavior, wherein the indication of team member behavior includes at least one behavior term and at least one team member reference;
determine, based on output of one or more rule-based models, whether the message includes an indication of a type of team member behavior, wherein the indication of the type of team member behavior includes:
a type of behavior term at a first location within the message, wherein the type of behavior term comprises one of an allegation term or a negative behavior term, and
a type of team member reference at a second location within the message that is proximate to the first location within the message, wherein the type of team member reference comprises one of a specific team member reference or a general team member reference; and
based on the message including the indication of team member behavior, send the message to another system corresponding to the type of team member behavior included in the message.
